(19) United States
(12) Patent Application Publication
(10) Pub. No.: US 2009/0129740 A1
(43) Pub. Date: May 21, 2009

(54) SYSTEM FOR INDIVIDUAL AND GROUP EDITING OF NETWORKED TIME-BASED MEDIA

(76) Inventors: Christopher J. O'brien, Brooklyn, NY (US); Andrew Wason, Atlantic Highlands, NJ (US)

Correspondence Address: LACKENBACH SIEGEL, LLP, LACKENBACH SIEGEL BUILDING, 1 CHASE ROAD, SCARSDALE, NY, 10583, US

(21) Appl. No.: 12/294,595

(22) PCT Filed: Mar. 28, 2007
(86) PCT No.: PCT/US07/65391

§ 371 Date: Sep. 25, 2008

Related U.S. Application Data
(60) Provisional application No. 60/787,105, filed on Mar. 28, 2006.
(60) Provisional application No. 60/787,069, filed on Mar. 28, 2006.
(60) Provisional application No. 60/787,393, filed on Mar. 29, 2006.
(60) Provisional application No. 60/746,193, filed on May 2, 2006.
(60) Provisional application No. 60/822,925, filed on Aug. 18, 2006.
(60) Provisional application No. 60/822,927, filed on Aug. 19, 2006.

(51) Int. Cl. H04N 5/93

(52) U.S. Cl. 386/52; 386/E05.001

(57) ABSTRACT

The present invention provides an easy to use web-based editing tool for time-based video content and media. The proposed system operates with metadata drivers for controlling a playing device without changing underlying encoded video data by tracking and recording playback decision actions by an operator/editor/user. Multiple user edits and multiple edit levels are enabled by tracking each step of the playback decision action and linking each to the underlying time-based video media.

### CROSS REFERENCE TO RELATED APPLICATIONS

This application relates to and claims priority from the following pending applications; U.S. Prov. App. No. 60/787,105 filed Mar. 28, 2006 (Ref. Motio.P001), U.S. Prov. App. No. 60/787,069 filed Mar. 28, 2006 (Ref. Motio.P002), U.S. Prov. App. No. 60/787,393 filed Mar. 29, 2006 (Ref. Motio.P003), U.S. Prov. App. No. 60/822,925 filed Aug. 18, 2006 (Ref. Motio.P004), U.S. Prov. App. No. 60/746,193 filed May 2, 2006 (Ref. Motio.P005), and U.S. Prov. App. No. 60/822,927 filed Aug. 19, 2006 (Ref. Motio.P006), the contents of each of which are fully incorporated herein by reference.

### FIGURE SELECTED FOR PUBLICATION

FIG. 3

### BACKGROUND OF THE INVENTION

1. Field of the Invention

The present invention relates to a system, method, data model, and a computer system architecture for improved uploading, storing, shared viewing, editing, manipulation, and operations involving video and time-based media. More specifically, the present invention relates a system for organizing, a method for manipulating, editing, and viewing time-based media such as digitally encoded video with synchronized audio and edits thereto.

2. Description of the Related Art

Consumers are shooting more and more personal video using camera phones, webcams, digital cameras, camcorders and other devices, but consumers are typically not skilled videographers nor are they able or willing to learn complex, traditional video editing and processing tools like Apple iMovie or Windows Movie Maker. Nor are most users willing to watch most video “VCR-style”, that is in a steady steam of unedited, undirected, unlabeled video.

Thus consumers are being faced with a problem that will be exacerbated as both the number of videos shot and the length of those videos grows (supported by increased processing speeds, memory and bandwidth in end-user devices such as cell phones and digital cameras) while the usability of editing tools lags behind. The result will be more and longer video files whose usability will continue to be limited by the inability to locate and access granular segments of interest within the larger video.

Those skilled in the art should recognize the more generic terminology “time-based media” which encompasses not only video with synchronized audio but also audio alone plus also a range of animated graphical media forms ranging from sequences of still images to what is commonly called ‘cartoons’. All of these forms are addressed herein. The terms video, time-based media, and digitally encoded video with synchronized audio (DEVSA) are used as terms of convenience herein with the intention to encompass all examples of time-based media.

A further detriment to the consumer is that video processing uses a lot of computer power and special hardware often not found on personal computers. Video processing also requires careful hardware and software configuration by the consumer. Consumers need ways to edit video without having to learn new skills, buy new software or hardware, become expert systems administrators or dedicate their computers to video processing for great lengths of time.

Consumers have been limited to editing and sharing video that they could actually get onto their computers, which requires the right kind of hardware to handle their own video, and also requires physical movement of media and encoding if they wish to use video shot by another person or which is taken from stock libraries.

When coupled with the special complexities of digitally encoded video with synchronized audio, the requirements for special hardware, difficult processing and storage demands combine to reverse the common notion of using “free desktop MIPS and GBs” to relieve central servers. Unfortunately, for video review and editing the desktop is just is not enough for most users. The cell phone is certainly not enough, nor is the Personal Digital Assistant (PDA). There is, therefore, a need for an improved method and system for shared viewing and editing of time-based media.

Those with skill in the conventional arts should readily understand that the terms “video” and “time-based media” as used herein are terms of convenience and should be interpreted generally below to mean “DEVSA” including content in which the original content is graphical.

Currently available editing tools are typically too difficult and time consuming for consumers to use, largely deriving from their reliance on the same user interface metaphors and import-edit-render pattern of high-end commercial video editing packages like Avid. One form of editing is to reduce the length and/or to rearrange segments of longer form video from camcorders by deleting unwanted segments and by cut-and-paste techniques. Another form of editing is to combine shorter clips (such as those from devices such as cell phones) into longer, coherent streams. Editors can also edit—or make “mixes”—using video and/or audio produced by others if appropriate permission is granted.

This application addresses a unique consumer and data model and other systems that involve manipulation of time-based media. As introduced above, those of skill in the art reviewing this application will understand that the detailed discussion below addresses novel methods of receiving, managing, storing, manipulating, and delivering digitally encoded video with synchronized audio. (Conveniently referred to as “digitally encoded video with synchronized audio” (DEVSA)).

In order to understand the concepts provided by the present, and related inventions, those of skill in the art should understand that DEVSA data is fundamentally distinct from and much more complex than data of those types more commonly known to the public and the broad data processing community and which is conventionally processed by computers such as basic text, numbers, or even photographs, and as a result requires novel techniques and solutions to achieve commercially viable goals (as will be discussed more fully below).

Operative and programming techniques (editing, revising, compaction, etc.) previously applied to these other forms of data types cannot be reasonably extended due to the complexity of the DEVSA data, and if commonly known forceful extensions are orchestrated they would:
Be ineffective in meeting users' objectives and/or
Be infeasible economically for non-professional users and/or
Make the so-rendered DEVSA data effectively inoperable in a commercially realistic manner.

Therefore, a person skilled in the art of text or photo processing cannot easily extend the known techniques to DEVSA.

What is proposed for the present invention is a new system and method for managing, storing, manipulating, editing, operating with and delivering, etc. DEVSA data. As will be discussed herein the demonstrated state-of-the-art in DEVSA processing suffers from a variety of existing, fundamental problems associated with known DEVSA data operations. The differences between DEVSA and other data types and the consequences thereof are discussed in the following paragraphs.

This application does not principally address new techniques for digitally encoding video and/or audio or for decoding DEVSA. There is substantive related art in this area that can provide a basic understanding of the same and those of skill in the electronic arts know these references. Those of skill in the art will understand however that more efficient encoding/decoding to save storage space and to reduce transmission costs only serves to greatly exacerbate the problems of operating on DEVSA and having to re-save revised DEVSA data at each step of an operation.

A distinguishing point about video and, by extension, stored DEVSA, is to emphasize that video or stored DEVSA represents an object with four dimensions: X, Y, A-audio, and T-time, whereas photos can be said to have only two dimensions (X, Y) and can be thought of as a single object that has two spatial dimensions but no time dimension. The difficulty in dealing with mere two dimensional photo technology is therefore so fundamentally different as to have no bearing on the present discussion (even more lacking are text art solutions).

Another distinguishing point about stored DEVSA that illustrates its unique difficulty in editing operations is that it extends through time. For example, synchronized (time-based) comments are not easily addressed or edited by subsequent users.

Those with skill in the art should be aware of an obvious example of the challenges presented by this time dependence in that it is common for Internet users to post comments on Web sites about specific news items, text messages, photos or other objects which appear on Web sites. The techniques for doing so are well known to those with skill in the art and are commonly used today. The techniques are straightforward in that the comment is a fixed, single data object, and the object commented upon is a fixed, single data object. However the corollaries in the realm of time-based media are not known and not supported within the current art.

As an illustrative example, consider the fact that video may extend for five minutes and encompass 7 distinct scenes addressing 7 distinct subjects. If an individual wishes to comment upon scene 5/subject 5, that comment would thus make no sense if it were tied to the video as a whole. The comment must be tied only to scene 5 that happens to occur from 3 minutes 22 seconds until 4 minutes 2 seconds into the video.

Since the video is a time-based data object, the comment must also become a time-based data object and be linked within the time space of the specific video to the segment in question. Such time-based comments and such time-dependent linkages are not known or supported within the related arts but are supported within this model.

A stored DEVSA represents an object with four dimensions: X, Y, A, T: large numbers of pixels arranged in a fixed X-Y plane which vary smoothly with T (time) plus A (audio amplitude over time) which also varies smoothly in time in synchrony with the video. For convenience this is often described as a sequence of “frames” (such as 24 frames per second). This is however a fundamentally arbitrary choice (number of “frames” and use of “frame” language) and is a settable parameter at encoding time. In reality the time variance of the pixel's change with time is limited only by the speed of the semiconductors that sense the light.

Before going further it is also important for those of skill in the art to understand the scale of these DEVSA data elements that sets them apart from other text or photo data elements. As a first example, a 10-minute video at 24 “frames” per second would contain 14,400 frames. At 600×800 pixel resolution, 480,000 pixels, one approaches 7 billion pixel representations.

When one adds in the fact that each pixel needs 10- to 20 bits to describe it and the need to simultaneously describe the audio track, there is a clear and an impressive need for an invention that addresses both the complexity of the data and the fact that the DEVSA represents not a fixed, single object rather a continuous stream of varying objects spread over time whose characteristics can change multiple times within a single video record. To date, no viable solutions have been provided which are accessible to the typical consumer, other than very basic functions such as storing pre-encoded video files and manipulating those fixed files.

While one might have imagined that photos and video offer similar technical challenges, the preceding discussion makes it clear again that the difficulties in dealing with mere two dimensional photos which are fixed in time are therefore so fundamentally different as to have no bearing on the present discussion.

Some additional facts about DEVSA should be well understood by those of skill in the art; and these include:
a. Current decoding technology allows one to select any instant in time within a video and resolve a “snapshot” of that instant, in effect rendering a photo of that instant and to save that rendering in a separate file. As has been shown, for example in surveillance applications, this is a highly valuable adjunctive technology but it is entirely inadequate to address the present needs.
b. It is not possible to take a “snapshot” of audio as it is perceived by a person. Those of skill in the electronic and audio-electronic arts recognize that audio data is a one dimensional data type: (amplitude versus time). It is only that as amplitude changes with time that it is perceivable by a person. Electronic equipment can measure that amplitude if desired for special reasons.

The present application, and those related family applications apply to this understanding of DEVSA when the actual video and audio is compressed (as an illustration only) by factors of a thousand or more but remains nonetheless very large files. Due the complex encoding and encodation techniques employed, those files cannot be disrupted or manipulated without a severe risk to the inherent stability of the underlying video and audio content.

The conventional manner in which users edit digitized data, whether numbers, text, graphics, photos, or DEVSA, is to display that data in viewable form, make desired changes to that viewable data directly and then re-save the now-changed data in digitized form.

The phrase above, “make desired changes to that viewable data”, could also be stated as “make desired changes to the manner in which that data is viewed” because what a user “views” changes because the data changes, which is the normative modality. In contrast to this position, the proposed invention changes the viewing of the data without changing the data itself. The distinction is material and a fundamental.

In conventional data changes, where storage cost is not an issue to the user, the user can choose to save both the original and the changed version. Some sophisticated commercial software for text and number manipulation can remember a limited number of user-changes and, if requested, display and, if further requested, may undo prior changes.

This latter approach is much less feasible for photos than for text or numbers due to the large size and the extensive encoding required of photo files. It is additionally far less feasible for DEVSA than for photos because the DEVSA files are much larger and because the DEVSA encoding is much more complex and processor intensive than that for photo encoding alone.

In a similar analysis, the processing and storage costs associated with saving multiple old versions of number or text documents is a small burden for a typical current user. However, processing and storing multiple old versions of photos is a substantial burden for typical consumer users today. Most often, consumer users store only single compressed versions of their photos. Ultimately, processing and storing multiple versions of DEVSA is simply not feasible for any but the most sophisticated users even assuming that they have use of suitable editing tools.

As will be discussed, this application proposes new methodologies and systems that address the tremendous conventional challenges of editing heavily encoded digitized media such as DEVSA.

In a parallel problem, known to those with skill in the conventional arts associated with heavily encoded digitized media such as DEVSA, is searching for content by various criteria within large collections of such DEVSA.

Simple examples of searching digitized data include searching through all of one's accumulated emails for the text word “Anthony”. Means to accomplish such a search are conventionally known and straight-forward because text is not heavily encoded and is stored linearly. On the Internet, companies like Google and Yahoo and many others have developed and used a variety of methods to search out such text-based terms (for example “Washington's Monument”). Similarly, number-processing programs follow a related approach in finding instances of a desired number (for example the number “$1,234.56”).

However, when the conventional arts approach digitally encoded graphics or, more challengingly, digitally encoded photos, and even more challengingly, DEVSA, managing problem becomes severe because the object of the search becomes less and less well-defined in terms, (1) a human can explain to a computer, and (2) a computer can understand and use algorithmically. Moreover, the data is ever more deeply encoded as one goes from graphics to photos to DEVSA.

Conventional efforts to employ image recognition techniques for photos and video, and speech recognition techniques for audio and video/audio, require that the digitized date be decoded back to viewable/audible form prior to application such techniques. As will be discussed later, repetitive encoding/decoding with edits introduces substantial risks for graphical, photographic, audio and video data.

As an example of this substantial risk, consider the superficially simple graphics search question: “Search the file XYZ graph which includes 75 figures and find all the elements which are “ovals”.”

If the search is being done with the same software which created the original file, the search may be possible. However, if the all the user has are images of the figures, the challenges are substantial. To name a few:
1. The user and the computer first have to agree on what “oval” means. Consider the fact that circles are “ovals” with equal major and minor axes.
2. The user and computer have to agree if embedded figures such as pictures or drawings of a dog should be included in the search since the dog's eyes may be “oval”.
3. The user and computer have to agree if “zeros” and/or “O's” are ovals or just text.

The point is that recognizing shapes gets tricky.

Turning to photos, unless there are metadata names or tags tied to the photo, which explain the content of the photo, determining the content of the photo in a manner susceptible to search is a largely unsolved problem outside of very specialized fields such as police ID photos. Distinguishing a photo of Mt. Hood from one of Mt. Washington by image recognition is extremely difficult.

This application proposes new methods, systems, and techniques to enable and enhance use, editing and searching of DEVSA files via use of novel types of metadata and novel types of user interactions with integrated systems and software. Specifically related to the distinction made above, this application addresses methods, systems and operational networks that provide the ability to change the manner in which users view digitized data, specifically DEVSA, without necessarily changing the underlying digitized data.

Those of skill in the art will recognize that there has been a tremendous commercial and research demand to cure the long-felt-problem of data loss where manipulating the underlying DEVSA data in situ.

Repetitive encoding and decoding cycles are very likely to introduce accumulating errors with resultant degradation to the quality of the video and audio. Therefore there is strong demand to retain copies of original files in addition to re-encoded files. Since, as stated previously, these are large files even after efficient encoding, economic pressures make it very difficult to keep many copies of the same original videos.

Thus, the related art in video editing and manipulation favors light repetitive encoding which in turn uses lots of storage and requires keeping more and more copies of successive versions of the encoded data to avoid degradation thus requiring even more storage. As a consequence, those of skill in the art will recognize a need to overcome the particular challenges presented by the current solutions to manipulation of time-based media.

As an illustrative example only, those of skill in the art should recognize the below comparison between DEVSA and other somewhat related data types.

The most common data type on computers (originally) was or involved numbers. This problem was well solved in the 1950s on computers and as a material example of this success one can buy a nice calculator today for $9.95 at a local non-specialty store. As another example, both Lotus® and now Excel® software systems now solve most data display problems on the desktop as far as numbers are concerned.

Today the most common data type on computers is text. Text is a one-dimensional array of data: a sequence of characters. That is, the characters have an X component (no Y or other component). All that matters is their sequence. The way in which the characters are displayed is the choice of the user. It could be on an 8×10 inch page, on a scroll, on a ticker-tape, in a circle or a spiral. The format, font type, font size, margins, etc. are all functions added after the fact easily because the text data type has only one dimension and places only one single logical demand on the programmer, that is, to keep the characters in the correct sequence.

More recently a somewhat more complex data type has become popular, photos or images. Photos have two dimensions: X and Y. A photo has a set of pixels arranged in a fixed X-Y plane and the relationship among those pixels does not change. Thus, those of skill in the art will recognize that the photo can be treated as a single object, fixed in time and manipulated accordingly.

While techniques have been developed to allow one to “edit” photos by cropping, brightening, changing tone, etc., those techniques require one to make a new data object, a new “photo” (a newly saved image), in order to store and/or retrieve this changed image. This changed image retains the same restrictions as the original: if one user wants to “edit” the image, the user needs to change the image and re-save it. It turns out that there is little “size”, “space”, or “time” penalty to that approach to photos because, compared to DEVSA, images are relatively small and fixed data objects.

In summary, DEVSA should be understood as a type of data with very different characteristics from data representing numbers, text, photos or other commonly found data types. Recognizing these differences and their impacts is fundamental to the proposed invention. As a consequence, an extension of ideas and techniques that have been applied to those other, substantially less complex data types, have no corollary to those conceptions and solutions noted below.

The present invention provides a new manner of (and new solution for) dealing with DEVSA type data that both overcomes the detriments of such data noted above and results in a substantial improvement demonstrated via the present invention and method.

The present invention also recognizes the earlier-discussed need for a system to manage DEVSA data while providing extremely rapid response to user input without changing the underlying DEVSA data.

What is also needed is a new manner of dealing with DEVSA that overcomes the detriments inherent in such data and that enables immediate and timely response to both initial DEVSA data, and especially that DEVSA data and time-based media in general, that is amended or updated on a continual or rapidly changing basis.

What is not appreciated by the related art is the fundamental data problem involving DEVSA and current systems for manipulating the same in a consumer responsive manner.

What is also not appreciated by the related art is the need for providing a data model that accommodates (effectively) all present modern needs involving high speed and high volume video data manipulation.

Accordingly, there is a need for an improved system and data model for shared viewing and editing of time-based media.

### SUMMARY OF THE INVENTION

The present invention proposes a response to the detriments noted above.

Another proposal of this invention is to provide extremely easy-to-use network-based tools which enable individuals, who may be professional experts or may be amateur consumers (both are referred to herein as users or editors), to upload their videos and accompanying audio and other data (hereinafter called videos) to the Internet, to “edit” their videos in multiple ways and to share those edited videos with others to the extent the editor chooses.

It is further proposed that the present invention include an editing capability that includes, but is not limited to, functions such as abilities to add video titles, captions and labels for sub-segments in time of the video, lighting transitions and other visual effects as well as interpolation, smoothing, cropping and other video processing techniques, both under user-control and automatically.

The present invention additionally proposes a new manner of (new solution for) dealing with DEVSA type data that both overcomes the challenges presented by such data and results in a substantial improvement in operational utility.

Another proposal of the present invention is to provide a system for editing videos for private use of the originator or that may be shared with others in whole or in part according to permissions established by the originator, with different privacy settings applying to different time sub-segments of the video.

Another proposal of the present invention is to provide an editing system wherein if users or editors desire, multiple viewable versions are easily created of a video targeted to specific sub-audiences based, for example, on the type of display device used by such sub-audience.

Another proposal of the present invention is to reduce the dependencies on the user's computer or other device, to avoid long user-learning curves, and to reduce the need for the user to purchase new desktop software and hardware, through the method of having video processing and storage take place on powerful and reliable server computers accessible via the Internet.

Another proposal of the present invention is to provide an editing system capable of coping with future advances in consumer or network-based electronics and readily permitting migration of certain software and hardware functions from a central servers to consumer electronics including personal computers and digital video recorders or to network-based electronics such as transcoders at the edge of a wireless or cable video-on-demand network without substantive change to the solutions described herein.

A further proposal is that videos and associated data linked with the video content may be made available to viewers across multiple types of electronic devices and who are linked via data networks of variable quality and speed, wherein, depending on the needs of that user and that device and the qualities of the network, the video may be delivered as a real-time stream or downloaded in encoded form to the device to be played back on the device at a later time.

Another proposal is to accomplish all of these and other capabilities in a manner, which provides for efficient and cost-effective information systems design and management.

Another proposal of the present invention is to provide an improved video operation system with improved user interaction over the Internet.

Another proposal of the present invention is to provide an improved system and data model for shared viewing and editing of a time-based media that has been encoded in a standard and recognized manner and optionally may be encoded in more than one manner.

Another object of the present invention is to provide a system, data model, and architecture that enables comments synchronized with DEVSA as it extends through time.

What is additionally proposed for the present invention is a new way for managing, storing, manipulating, operating with and delivering, etc. DEVSA data stored in a recognized manner using playback decision tracking, that is tracking the decisions of users of the manner in which they wish the videos to be played back which may take the form of Playback Decision Lists (PDLs) that operate as time-dependent metadata co-linked to particular DEVSA data.

Another proposal of the present invention is to provide a data system and operational model that enables generation and tracking of multiple and independent (hierarchical) layers of time-dependent metadata that are stored in a manner linked with video data that affect the way the video is played back to a user at a specific time and place without changing the underlying stored video reference.

It is another proposal of the present invention to provide a system, method, and operational model that tracks via time-dependent metadata (via play back decision track or PDLs) individual user preferences on how to view video.

Another proposal of the present invention is to enable a system for tagging video data to identify a specific user, in a specific hierarchy, in a specific modality (soccer, kids, fun, location, family, etc) while enabling a sharable or defined group interaction.

Another proposal of the present invention is to enable a operative system that determines playback decision lists (PDLs) and enables their operation both in real-time on-line viewing of DEVSA data and also enables sending the PDL logic to an end user device for execution on that local device, when the DEVSA is stored on or delivered to that end-user device, to minimize the total bit transfer at each viewing event thereby further minimizing response time and data transfer.

The present invention relates to a novel and easy to use web-based editing tool for time-based video content and media. The proposed system operates with metadata drivers for controlling a playing device without changing underlying encoded video data by tracking and recording playback decision actions by an operator/editor/user. Multiple user edits and multiple edit levels are enabled by tracking each step of the playback decision action and linking each to the underlying time-based video media.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 represents an illustrative flow diagram for an operational system and architectural model for one aspect of the present invention.

FIG. 2 represents an illustrative flow diagram of an interactive system and data model for shared viewing and editing of time-based media enabling a smooth interaction between a video media user and underlying stored DEVSA data.

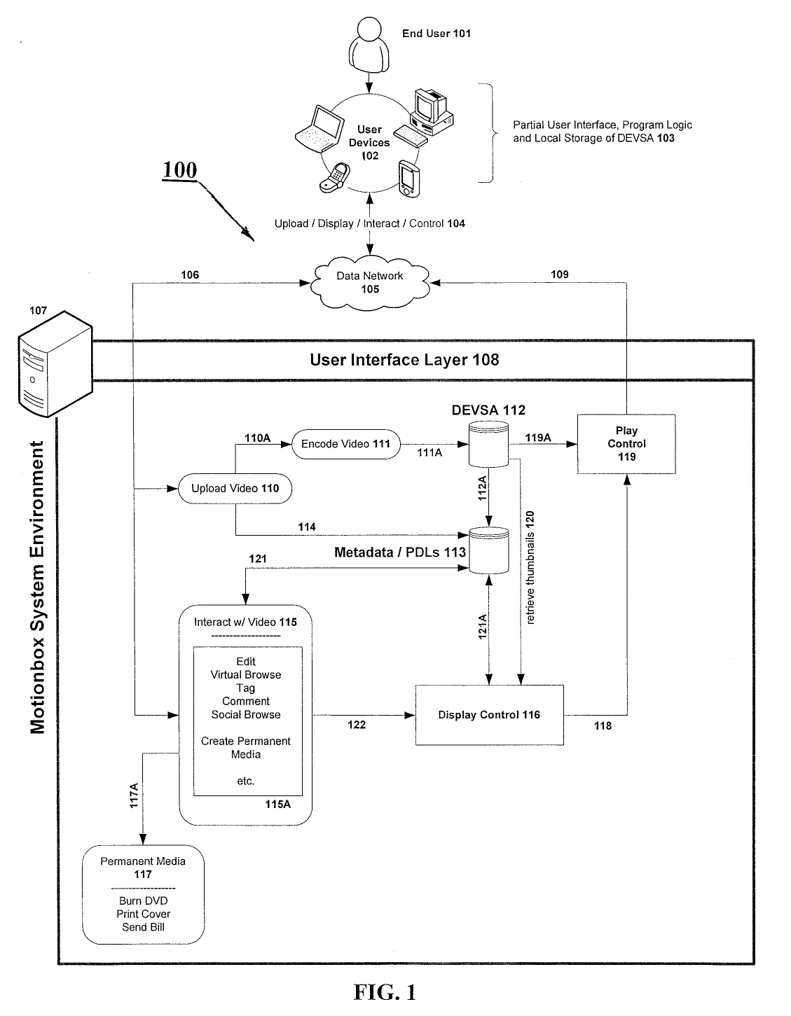

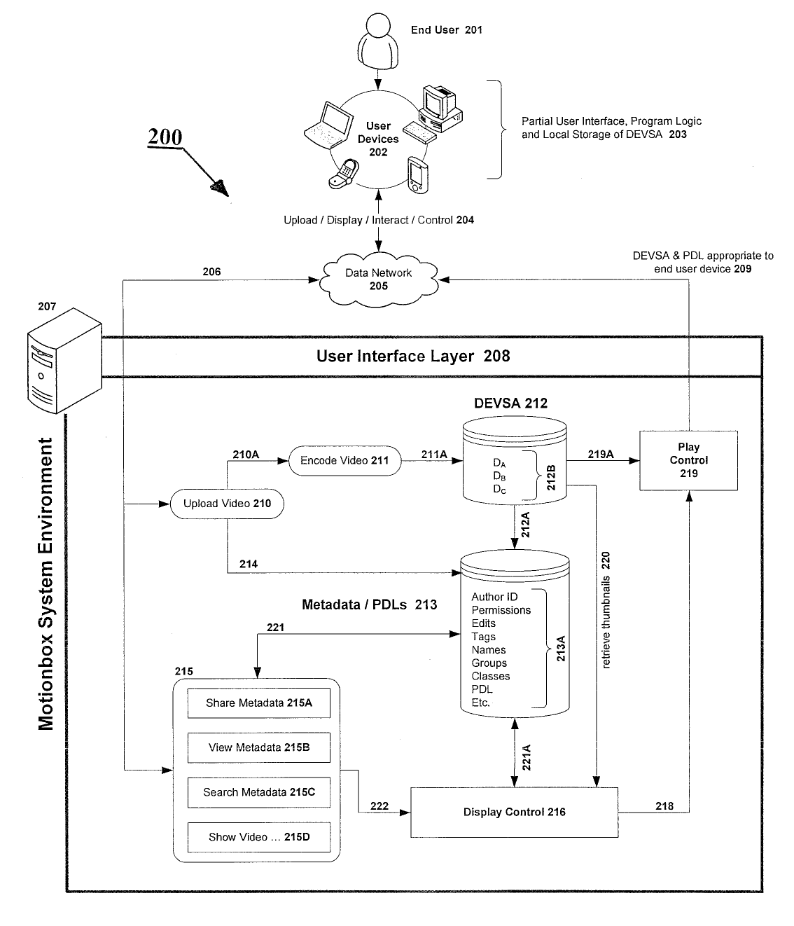

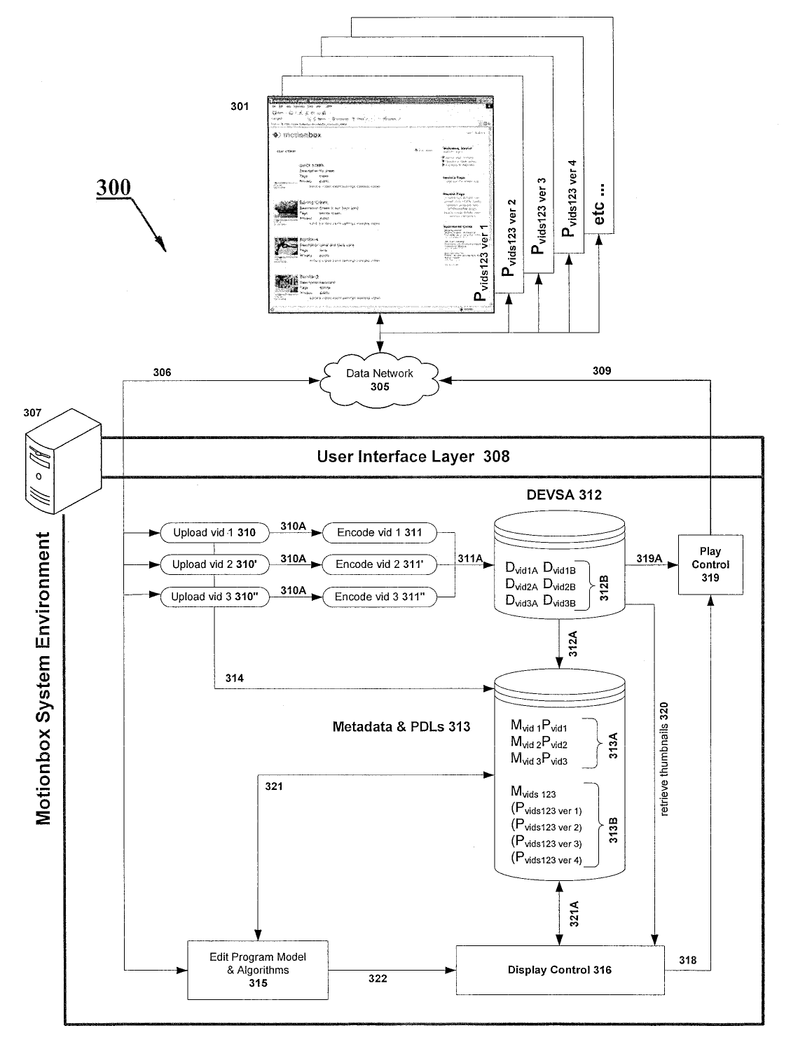

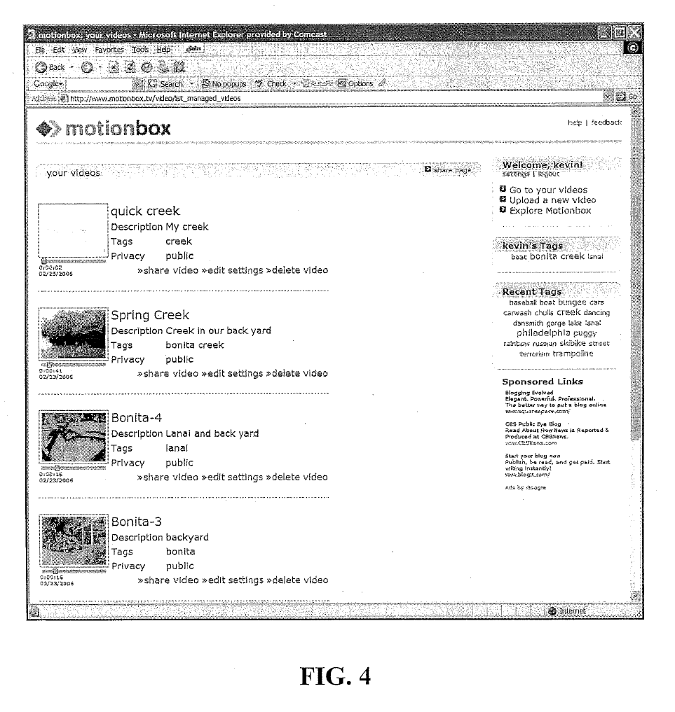

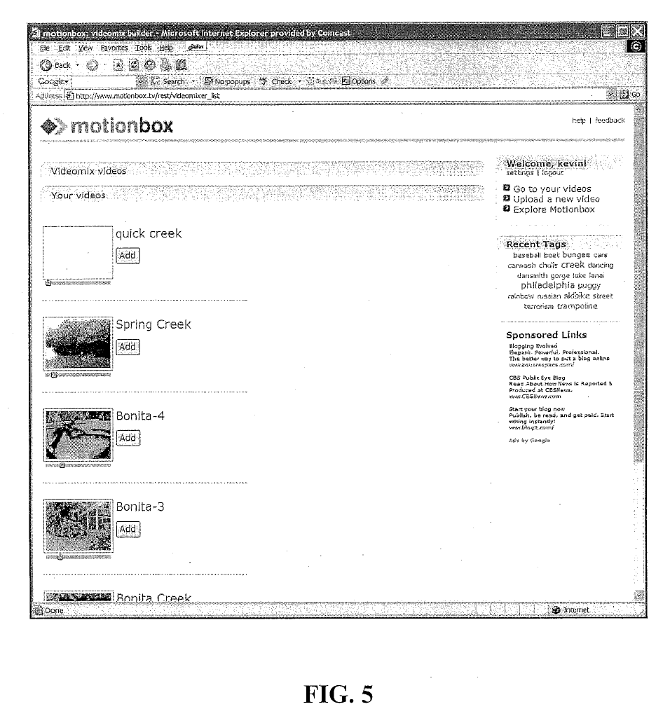

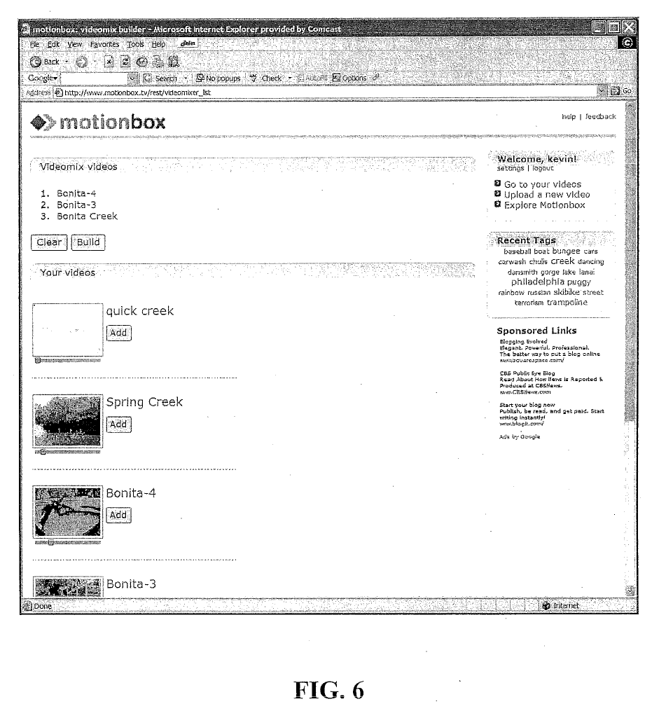

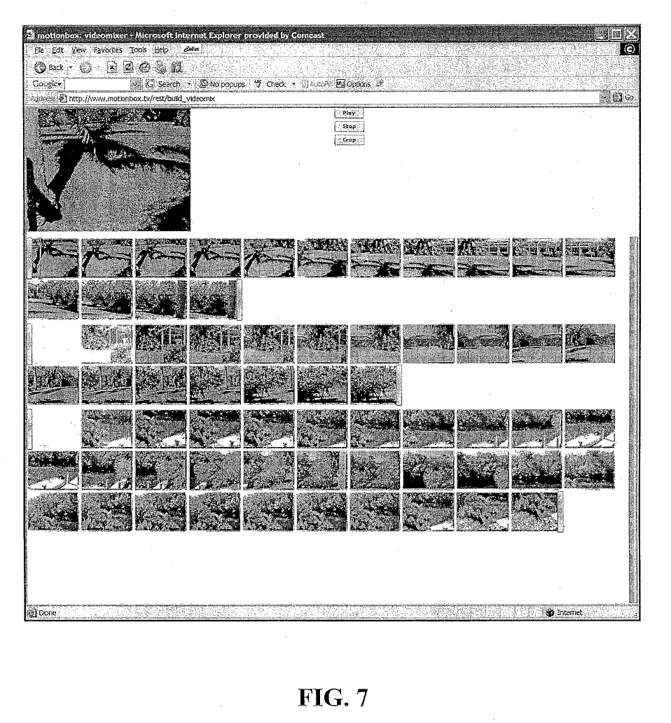

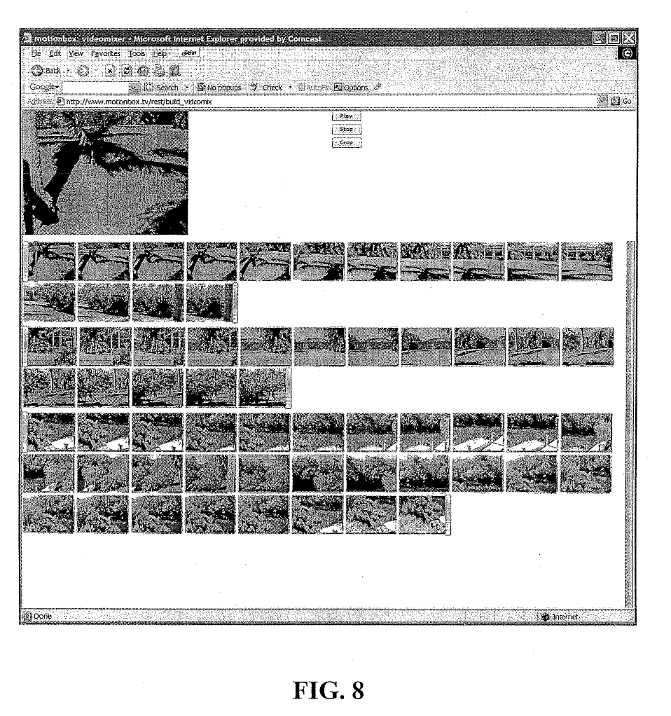

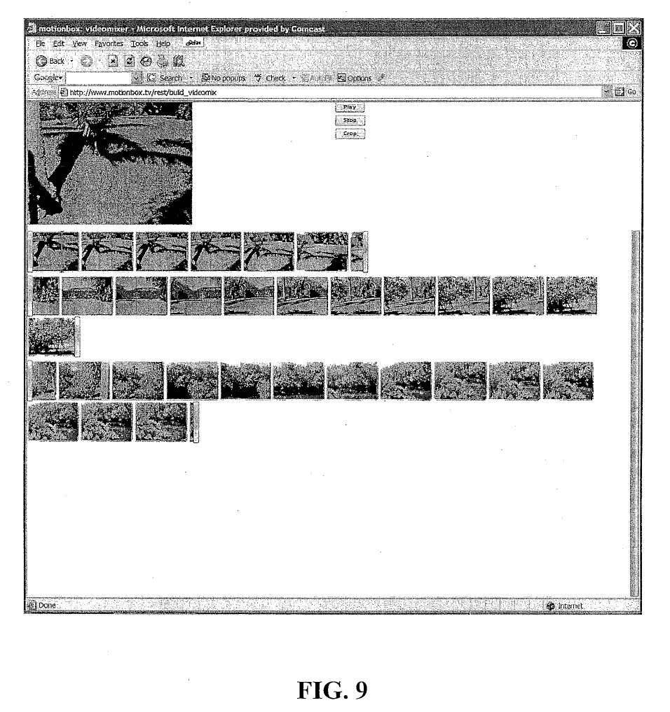

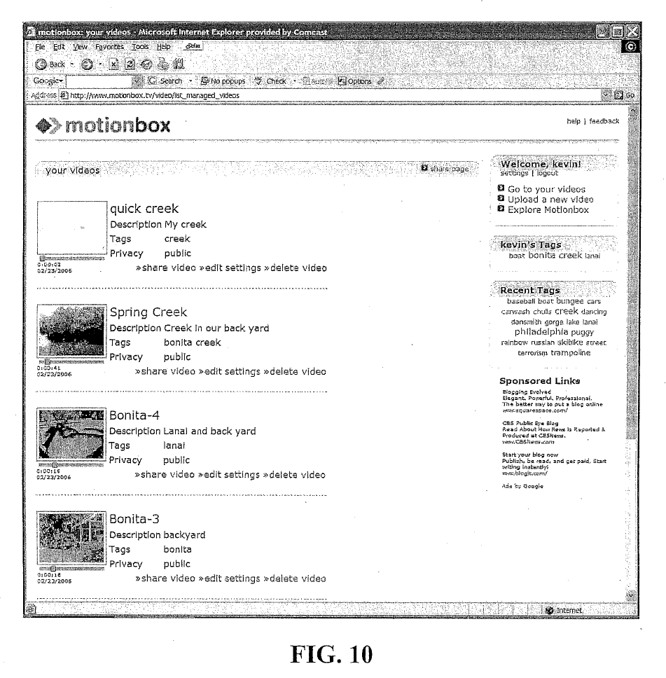

FIG. 3 is an illustrative flow diagram for a web-based system for enabling and tracking editing of personal video content.

FIG. 4 is a screen image of a first page of a user's list of the user's uploaded video data.

FIG. 5 is a screen image of edit and data entry page allowing a user to “add” one or more videos to a list of videos to be edited as a group.

FIG. 6 is a screen image of an “edit” and “build” step using the present system.

FIG. 7 is a screen image of an edit display page noting three videos successively arranged in text-like formats with thumbnails roughly equally spaced in time throughout each video. The large image at upper left is a ‘blow-up’ of the current thumbnail.

FIG. 8 is a screen image of a partially edited page where select frames with poor video have been “cut” by the user via ‘mouse’ movements.

FIG. 9 is a screen image of the original three videos where selected images of a “pool cage” were been “cut” during a video edit session (The user is now finished editing).

FIG. 10 is a screen image of the first pages of a user list of uploaded video data. The editing process has not altered the original videos.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

Before going further, and in order to fully appreciate the major innovation described in this and the related applications, it is necessary to introduce a new enabling concept which is referred to as the Playback Decision List or hereafter “PDL.” The PDL is a portion of metadata contained within a data model or operational system for manipulating related video data and for driving, for example, a flash player to play video data in a particular way without requiring a change in the underlying video data (DEVSA). This new concept of a PDL is best understood by considering its predecessor concepts that originated years ago in film production and are used today by expert film and video directors and editors.

The predecessor concept is an Edit Decision List or EDL. It is best described with reference to the production of motion picture. In such a production many scenes are filmed, often several times each, in a sequence that has no necessary relationship to the story line of the movie. Similarly, background music, special effects, and other add-ons are produced and recorded or filmed independently. Each of those film and audio elements is carefully labeled and timed with master lists.

When these master lists are complete, the film's director and editor sit down, often for a period of months, and review each element while gradually writing down and creating and revising an EDL which is a very detailed list, second by second, of which film sequences will be spliced together in what sequence perhaps with audio added to make up the entire film. Additionally, each sequence may have internal edits required such as fade-in/out, zoom-in/out, brighten, raise audio level and so on. The end result is an EDL. Technicians use the EDL to, literally in the case of motion picture to cut and paste together the final product. Some clips are just cut and “left on the cutting room floor.” Expert production of commercial video follows a very similar approach.

The fundamental point of an EDL is that one takes segments of film or video and audio and possibly other elements and links them together to create a new stream of film or video, audio, etc. The combining is done at the film or video level, often physically. The original elements very likely were cut, edited, cropped, faded in/out, or changed in other and may no longer even exist in their original form.

This EDL technique has proven to be extremely effective in producing high quality film and video. It requires a substantial commitment of human effort, typically many staff hours per hour of final media and is immensely costly. It further requires that the media elements to be edited be kept in viewable/hearable form in order to be edited properly. Such an approach is economically impossible when dealing with large quantities of consumer produced video. The PDL concept introduced herein provides a fundamentally different way to obtain a similar end result. The final “quality” of the video will depend on the skill and talent of the editor nonetheless.

The PDL incorporates as metadata associated with the DEVSA all the edit commands, tags, commentary, permissions, etc. introduced by a user via a user interface (as will be discussed). It is critical to recognize that multiple users may introduce edit commands, tags, commentary, permissions, etc. all related to the same DEVSA without changing the underlying video data. The user interface and the structure of the PDL allow a single PDL to retrieve data from multiple DEVSA.

The result is that a user can define, for example, what is displayed as a series of clips from multiple original videos strung together into a “new” video without ever changing the original videos or creating a new DEVSA file. Since multiple users can create PDLs against the same DEVSA files, the same body of original videos can be displayed in many different ways without the need to create new DEVSA files. These “new” videos can be played from a single or from multiple DEVSA files to a variety of end-user devices through the use of software and/or hardware decoders that are commercially available. For performance or economic reasons, copies or transcodings of certain DEVSA files may be created or new DEVSA files may be rendered from an edited segment, to better serve specific end-user devices without changing the design or implementation of the invention in a significant manner.

Since multiple types of playback mechanisms are likely to be needed such as one for PCs, one for cell phones and so on, the programming model will create a “master PDL” from which algorithms can create multiple variations of the PDL suitable for each of the variety of playback mechanisms as needed. The PDL executes as a set of instructions to the video player.

As discussed earlier, in certain cases it is advantageous to download an encoded file in a form suitable to a specific device type rather than stream a display in real time. In the “download” case, the system will create the file using the PDL and the DEVSA, re-encode it in the appropriate format, and then send that encoded file to the end-user device where it is stored until the user chooses to play it. This “download” case is primarily a change in the mode of delivery rather a fundamentally distinct methodology.

One crucial innovation introduced by PDL is that it controls the way the DEVSA is played to any specific user at any specific time. It is a control list for the DEVSA player (flash player/video player). All commands (edits, sequences, tags, comments, permissions, etc.) are executed at playback time while the underlying DEVSA does not change. This makes the PDL in stark contrast to an EDL which is a set of instructions to create a new DEVSA out of previously existing elements.

As will be discussed in further detail, the present invention includes, but is not limited to, three major, linked components, all driven from the central servers: a series of user interfaces; an underlying programming model and algorithms; and a data model.

All actual video manipulation is done on the server as discussed, but those of skill in the art will recognize that the present system may be application driven on a user PC with little modification. The “desktop” or other user interface device needs only to operate web browser software or the equivalent, a video & audio player which can meet the server's requirements and its own internal display and operating software and be linked to the servers via the Internet or another suitable data connection. As advances in consumer electronics permit, other implementations become feasible. In those alternative implementations certain functions can migrate from the servers to end user devices or to network-based devices without changing the basic design or intent of the invention.

A very useful feature of a successful video editing system is a flexible user interface that: (a) is consistent with typical user experience, but not necessarily typical video editing user interfaces, (b) will not place undue burdens on the end user's device, and (c) is truly linked to the actual DEVSA (as is discussed herein).

A major challenge to be overcome is that the DEVSA is a four dimensional entity which needs to be represented on a two dimensional display, a computer screen or the display of a handheld device such as a cell phone or an iPod®.

The present invention provides a highly flexible user interface and such tools are very important for successful video editing systems. The invention is also consistent with typical user experience with Internet-like interactions, but not necessarily typical video editing user interfaces, the invention will not place undue burdens on the end user's device, and the invention truly links actual DEVSA with PDL.

A major detriment to be overcome is that the DEVSA is a four dimensional entity which needs to be represented on a two dimensional display, a computer screen or the display of a handheld device such as a cell phone or an iPod®.

This invention takes the approach of creating an analog of a text document made up, not of a sequence of text characters, but of a sequence of “thumbnail” frame images at selected times throughout the video. For users who express the English language as a preference, these thumbnails are displayed from left to right in sequential rows flowing downward in much the way English text is displayed in a book. Other sequences will naturally be more appropriate for users whose written language progresses in a different manner.

A useful point is to have the thumbnails and the “flows” of the video follow a sequence similar to that of the user's written language; such as, left-to-right, top-to-bottom, right-to left. Images flowing right to left, bottom to top for users who are more comfortable with such an arrangement are a minor adjustment.

A selected frame may be enlarged and shown above the rows for easier viewing by the user. FIG. 1 shows an example. As a further example, a 5 minute video might be initially displayed as 15 thumbnail images spaced about 20 seconds apart in time through the video. This user interface allows the user to quickly grasp the overall structure of the video. The choice of 15 images rather than some higher or lower number is initially set by the server administrator but when desired by the user can be largely controlled by the user as he/she is comfortable with the screen resolution and size of the thumbnail image.

By means of a mouse (or equivalent) or keyboard commands, the user can “zoom in” on sub-sections of the video and thus expand to, for example, 15 thumbnails covering 1 minute of video so that the thumbnails are only separated by about 4 seconds. Whenever desired, the user can “zoom-in” or “zoom-out” to adjust the time scale to meet the user's current editing or viewing needs.

One approach is the so-called “slider” wherein the user highlights a selected portion of the video timeline causing that portion to be expanded (zoomed-in) causing additional, more closely placed thumbnails of just that portion to be displayed. Additionally, other view modes can be provided, for example the ability to see the created virtual clip in frame (as described herein), clip (where each segment is shown as a single unit), or traditional video editing time based views.

Additional methods of displaying thumbnails over time can also be used to meet specific user needs. For example thumbnails may also be generated according to video characteristics such as scene transitions or changes in content (recognized via video object recognition).

The user interfaces allow drag and drop editing of different video clips with a level of ease similar to that of using a word processing application such as Microsoft Word®, but entirely within a web browser. The user can remove unwanted sections of video or insert sections from other videos in a manner analogous to the cut/copy-and-paste actions done in text documents.

A noted previously, these “drag, drop, copy, cut, paste” edit commands are stored within the data model as metadata, do not change the underlying DEVSA data, and are externally time dependent if desired.

The edit commands, tags and commentary can all be externally time-dependent at the user's option. As an elementary example, “If this is played between March 29 and March 31, Play Audio: “HAPPY BIRTHDAY”.

Other user interface representations of video streams on a two dimensional screen are also possible and could also be used without disrupting the editing capabilities described herein. One example is to arrange the page of thumbnail images in time sequence as if they were a deck of cards or a book thus creating an apparent three-dimensional object where the depth into the “deck of cards” or the “book” is a measure of time.

Graphical “tabs” could appear on the cards or book pages (as on large dictionaries) which would identify the time (or other information) at that depth into the deck or book. The user could then “cut the deck” or “open the book” at places of his choosing and proceed in much the same way as described above. These somewhat different representations would not change the basic nature of the claims herein. There can be value in combining multiple such representations to aid users with diverse perception preferences or to deal with large quantities of information.

In the preceding it has been assumed that the “user” has the legal right to modify the display of the DEVSA, which may be arguably distinguished from a right to modify the DEVSA itself. There may be cases where there are users with more limited rights. The user interface will allow the individual who introduces the video and claims full edit rights, subject to legal review, to limit or not to limit the rights of others to various viewing permissions and so-called editing functions (these are “modifying the display” edits noted earlier). These permissions can be adjusted within various sub-segments of the video. It is expected that the addition of tags and commentary by others will not generally be restricted in light of the fact that the underlying DEVSA is not compromised by these edit commands as is explained more fully below.

Having completed the overall supporting discussion, reference is now made to FIG. 1, an architectural review of a system model 100 for improving manipulation and operations of video and time-based DEVSA data. It should be understood, that the term “video” is sometimes used below as a term of convenience and should be interpreted to mean DEVSA or more broadly time-based media.

In viewing the technological architecture of system model 100, those of skill in the art will recognize that an end user 101 may employ a range of known user device types 102 (such as PCs, cell phones, PDAs, iPods et al.) to create and view DEVSA/video data.

Devices 102 include a plurality of user interfaces, operational controls, video management requirements, programming logic, local data storage for diverse DEVSA formats, all represented via capabilities 103.

Capabilities 103 enable a user of a device 102 to perform multiple interaction activities 104 relative to a data network 105. These activities 104 are dependent upon the capacities 103 of devices 102, as well as the type of data network 105 (wireless, dial, DSL, secure, non-secure, etc.).

Activities 104 including upload, display, interact, control, etc. of video, audio and other data via some form of data network 105 suited to the user device in a manner known to those of skill in the art. The user's device 102, depending on the capabilities and interactions with the other components of the overall architecture system 100, will provide 103 portions of the user interface, program logic and local data storage.

Other functions are performed within the system environment represented at 107 which typically will operate on servers at central locations while allowing for certain functionality to be distributed through data network 105 as technology allows and performance and economy suggest without changing the architecture and processes as described herein.

All interactions between system environment 107 and users 101 pass through a user interface layer 108 which provides functionality commonly found on Internet or cell phone host sites such as security, interaction with Web browsers, messaging etc. and analogous functions for other end user devices.

As discussed, the present system 100 enables user 101 to perform many functions, including uploading video/DEVSA, audio and other information from his end user device 102 via data network 105 into system environment 107 via a first data path 106.

First data path 106 enables an upload of DEVSA/video via program logic upload process loop 110. Upload process loop 110 manages the uploading process which can take a range of forms.

For example, in uploading video/DEVSA from a cell phone, the upload process 110 can be via emailing a file via interactions 104 and data network 105. In a second example, for video captured by a video camera, the video may be transferred from the camera to the user's PC (both user devices 102) and then uploaded from the PC to system environment 107 web site via the Internet in real time or as a background process or as a file transfer. Physical transmission of media is also possible.

During system operation, after a successful upload via uploading process loop 110, each video is associated with a particular user 101 and assigned a unique user and upload and video identifier, and passed via pathway 110A to an encode video process system 111 where it is encoded into one or more standard forms as determined by the system administrators or in response to a user request. The encoded video/DEVSA then passes via conduit 111A to storage in the DEVSA storage files 112. At this time, the uploaded, encoded and stored DEVSA data can be manipulated for additional and different display (as will be discussed), without underlying change. As will be more fully discussed below, the present data system 100 may display DEVSA in multiple ways employing a unique player decision list (PDL) for tracking edit commands as metadata without having to re-save, and re-revise, and otherwise modify the initially saved DEVSA.

Additionally, and as can be viewed from FIG. 1, during the upload (105-106-110), encodation (110A-111), and storage (111A-112) processes stages of system 100; a variety of “metadata” is created about the DEVSA including user ID, video ID, timing information, encoding information including the number and types of encodings, access information, and many other types of metadata, all of which passes via communication paths 114 and 112A to the Metadata/PDL storage facility(ies) 113. There may be more than one Metadata/PDL storage facility. As will be later discussed, the PDL drives the software controller for the video player on the user device via display control 116/play control 119 (as will be discussed).

Such metadata will be used repeatedly and in a variety of combinations with other information to manage and display the DEVSA combined with the metadata and other information to meet a range of user requirements. The present system also envisions a controlled capacity to re-encode a revised DEVSA video data set without departing from the scope and spirit of the present invention.

It is expected that many users and others including system administrators will upload (over time) many DEVSA to system environment 107 so that a large library of DEVSA (stored in storage 112) and associated metadata (stored in storage 113) will be created by the process described above.

Following the same data path 106 users can employ a variety of functions generally noted by interaction with video 115. Several types of functionalities 115A are identified as examples within interact with video module 115; including Editing, Virtual Browsing, Commenting, Social Browsing, etc. These functions include the user-controlled design and production of permanent DEVSA media such as DVDs and associated printing and billing actions 117 via a direct data pathway 117A, as noted. It should be noted that there is a direct data path between the DEVSA files 112 and the functions in 117 (not shown in the Figure for reasons of readability.)

Many of the other functions 115A are targeted at online and interactive display of video and other information via data networks. The functions 115 interact with users via communication path 106; and it should be recognized that functions 115A use, create, and store metadata 113 via path 121.

User displays are generated by the functions 115/115A via path 122 to a display control 116, which merges additional metadata via path 121A, thumbnails (still images derived from videos) from 112 via paths 120.

Thumbnail images are created during encoding process 111 and optionally as a real time process acting on the DEVSA without modifying the DEVSA triggered by one of the functions 115/115A (play, edit, comment, etc.) or by some other process.

Logically the thumbnails are part of the DEVSA, not part of the metadata, but they may be alternatively and adaptively stored as part of metadata in 113. An output of display control 116 passes via pathway 118 to play control 119 that merges the actual DEVSA from storage 112 via pathway 119A and sends the information to the data network 105 via pathway 109.

Since various end user devices 102 have distinct requirements, multiple Play Control modules may easily be implemented in parallel to serve distinct device types. It is also envisioned, that Distinct Play Control modules 119 may merge distinct DEVSA files of the same original video and audio with different encoding via 119A depending on the type of device being supported.

It is important to note that interactive functions 115/115A do not link directly to the DEVSA files stored at 112, only to the metadata/PDL files stored at 113. The display control function 116 links to the DEVSA files 112 only to retrieve still images. A major purpose of this architecture within system 100, is that the DEVSA, once encoded, is preferably not manipulated or changed—thereby avoiding the earlier noted concerns with repeated decoding, re-encoding and re-saving. All interactive capabilities are applied at the time of Play Control 119 as a read-only process on the DEVSA and transmitted back to user 110 via pathway 109.

Those with skill in the art should recognize that PDLs and other metadata as discussed herein can apply not only to real time playback of videos and other time-based media but also to the non-real-time playback of such media such as might be employed in the creation of permanent media such as DVDs.

Those of skill in the art will recognize that when a user creates a permanent media version 117, playback decision lists PDLs or playback decision preferences, evolve into edit decision lists (EDLs) or instructions that become a table of contents, index, or other operative instructions on a fixed media version (such as DVD).

Those of skill in the art should recognize the common understanding that tags are meta tags used to label and identify select portions of a video desired and perhaps to allow the sequential generation of a video compilation, whereas an EDL or edit decision list may be used to create a new whole media out of a plurality of previously labeled or tagged pieces/snippets. It should also be understood, that PDLs and EDLs are different in concept. EDLs (edit decision lists) are used to define how to encode/create/produce a content, whereas PDLs move all decisions into the player or video user without touching the raw encoded content.

Referring now to FIG. 2, in a manner similar to that discussed with FIG. 1, here an electronic system, integrated user interfaces, programming modules, and data model 200 describes the likely flows of information and control among various components noted therein. Again, as noted earlier, the term “video” is sometimes used below as a term of convenience and should be interpreted by those of skill in the art to mean DEVSA.

Here, an end user 201 may optionally employ a range of user device types 202 such as PCs, cell phones, iPods etc. which provide user 201 with the ability to perform multiple activities 204 including upload, display, interact, control, etc. of video, audio and other data via some form of a data network 205 suited to the particular user device 202.

User devices 202, depending on their capabilities and interactions with the other components of the overall architecture for proper functioning, will provide logic 203 portions of the user interface, program logic and local data storage, etc., as will also be discussed.

Other functions are performed within the proposed system environment 207 which typically operates on one or more servers at reliable or central locations while allowing for certain functionality to be distributed through the data network as technology allows and performance and economy suggest without changing the program or data model and processes as described herein.

As shown, interactions between system environment 207 and users 201 pass through a user interface layer 208 which is technology and systems structured to provide functionality commonly found on Internet or cell phone host sites such as security, interaction with Web browsers, messaging etc. and analogous functions for other end user devices.

As noted earlier, users 201 may perform many functions; including video, audio and other data uploading DEVSA from user device 202 via data network 205 into system environment 207 via data path 206.

An upload video module 210 provides program logic that manages the upload process which can take a range of forms. For video from a cell phone, the upload process may be via emailing a file via user interface 208 and data network 205. For video captured by a video camera, the video can be transferred from a camera to a user's PC and then uploaded from the PC to system environment 207 via the Internet in real time or as a background process or as a file transfer. Physical transmission of media is also possible.

During operation of system 200, and after successful upload, each video is associated with a particular user 201, assigned a unique identifier, and other identifiers, and passed via path 210A to an encode video process module 211 where it is encoded into one or more standard DEVSA forms as determined by a system administrators (not shown) or in response to a particular user's requests. The encoded video data then passes via pathway 211A to storage in DEVSA storage files 212.

Within DEVSA files in storage 212, multiple ways of encoding a particular video data stream are enabled; by way of example only, three distinct ways 212B, labeled D_{A}, D_{B}, D_{C}, are represented. There is no significance to the use of three as an example other than to illustrate that there are various forms of DEVSA encodation and to illustrate this diversity system 200 enables adaptation to any particular format desired by a user and/or specified by system administrators.

One or more of the multiple distinct methods of encoding may be chosen for a variety of reasons. Some examples are distinct encoding formats to support distinct kinds of end user devices (e.g., cell phones vs. PCs), encoding to enhance performance for higher and lower speed data transmission, encoding to support larger or smaller display devices. Other rationales known for differing encodation forms are possible, and again would not affect the processes or system and model 200 described herein. A critical point is that the three DEVSA files 212B labeled D_{A}, D_{B}, D_{C} are encodings of the same video and synchronized audio using differing encodation structures. As a result, it is possible to store multiple forms of the same DEVSA file in differing formats each with a single encodation process via encodation video 211.

Consequent to the upload, encode, store processes a plurality of metadata 213A is created about that particular DEVSA data stream being uploaded and encoded; including user ID, video ID, timing information, encoding information, including the number and types of encodings, access information etc. which passes by paths 214 and 212A respectively to the Metadata/PDL (playback decision list) storage facilities 213. Such metadata will be used repeatedly and in a variety of combinations with other information to manage and display the DEVSA combined with the metadata and other information to meet a range of user requirements.

Thus, as with the earlier embodiment shown in FIG. 1, those of skill in the art will recognize, that the present invention enables a single encodation (or more if desired) but many metadata details about how the encoded DEVSA media is to be displayed, managed, parsed, and otherwise processed.

It is expected that many users and others including system administrators (not shown) will upload many videos to system environment 207 so that a large library of DEVSA and associated metadata will be created by the process described above.

Following the same data path 206, users 201 may employ a variety of program logic functions 215 which use, create, store, search, and interact with the metadata in a variety of ways a few of which are listed as examples including share metadata 215A, view metadata 215B, search metadata 215C, Show Video 215D etc. These data interactions utilize data path 221 to the Metadata/PDL databases 213. A major functional portion of the metadata is Playback Decision Lists (PDLs) which are described in detailed in other, parallel submissions, each incorporated fully by reference herein. PDLs, along with other metadata, control how the DEVSA is played back to users and may be employed in various settings.

As was shown in FIG. 2 many of the other functions in program logic box 215 are targeted at online and interactive display of video and other information via data networks. As was also shown in FIG. 1, but not indicated here, similar combinations of metadata and DEVSA can be used to create permanent media.

Thus, those of skill in the art will recognize that the present disclosure also enables a business method for operating a user interface 208.

It is the wide variety of metadata, including PDLs, created and then stored which controls the playback of video, not a manipulation of the underlying and encoded DEVSA data.

In general the metadata will not be dependent on the type of end user device utilized for video upload or display although such dependence is not excluded from the present disclosure.

The metadata does not need to incorporate knowledge of the encoded DEVSA data other than its identifiers, its length in clock time, its particular encodings, knowledge of who is allowed to see it, edit it, comment on it, etc. No knowledge of the actual images or sounds contained within the DEVSA is required to be included in the metadata for these processes to work. While this point is of particular novelty, this enabling system 200 is more fully illustrative.

Such knowledge of the actual images or sounds contained within the DEVSA while not necessary for the operation of the current system enables enhanced functionalities. Those with skill in the art will recognize that such additional knowledge is readily obtained by means of techniques including voice recognition, image and face recognition as well as similar technologies. The new results of those technologies can provide additional knowledge that can then be integrated with the range of metadata discussed previously to provide enhanced information to users within the context of the present invention. The fact that this new form of information was derived from the contents of the time-based media does not imply that the varied edit, playback and other media manipulation techniques discussed previously required any decoding and re-encoding of the DEVSA. Such knowledge of the internal contents of the time-based media can be obtained by decoding with no need to re-encode the original video so the basic premises are not compromised.

User displays are generated by functions 215 via path 222 to Display Control 216 which merges additional metadata via path 221A, and thumbnails (still images derived from videos) from DEVSA storage 212 via pathway 220.

(Note that the thumbnail images are not part of the metadata but are derived directly from the DEVSA during the encoding process 211 or as a real time process acting on the DEVSA without modifying the DEVSA triggered by one of the functions 215 or by some other process. Logically the thumbnails are part of the DEVSA, not part of the metadata stored at 213, but alternative physical storage arrangements are envisioned herein without departing from the scope and spirit of the present invention.

An output of Display Control 216 passes via pathways 218 to play controller 219, which merges the actual DEVSA from storage 212 via data path 219A and sends the information to the data network via 209. Since various end user devices have distinct requirements, multiple Play Control modules may be implemented in parallel to serve distinct device types and enhance overall response to user requests for services and user speed.

Depending on the specific end user device to receive the DEVSA, the data network it is to traverse, and other potential decision factors such as the availability of remote storage, at playback time distinct Play Control modules will utilize distinct DEVSA such as files D_{A}, D_{B}, or D_{c} via 219A.

The metadata transmitted from display control 216 via 218 to the Play Control 219 includes instructions to play control 219 regarding how it should actually play the stored DEVSA data and which encode its use.

The following is a sample of a PDL—playback decision list—and a tracking of user decisions in metadata on how to display the DEVSA data. Note that two distinct videos (for example) are included here to be played as if they were one. A simple example of typical instructions, might be:

### Instruction:

Play video 174569, encoding b, time 23 to 47 seconds after start:
Fade in for first 2 seconds—personal decision made for tracking as metadata on PDL.
Increase contrast throughout—personal decision made for PDL.
Fade out last 2 seconds—personal decision made for PDL.

Play video 174569, encoding b, time 96 to 144 seconds after start
Fade in for first 2 seconds—personal decision made for PDL.
Increase brightness throughout—personal decision made for PDL.
Fade out last 2 seconds—personal decision made for PDL.

Play video 174573 (a different video), encoding b, time 45 to 74 seconds after start
Fade in for first 2 seconds—personal decision for PDL.
Enhance color AND reduce brightness throughout, personal decision for PDL.
Fade out last 2 seconds—personal decision for PDL.

The playback decision list (PDLs) instructions are those selected using the program logic functions 215 by users who are typically, but not always, the originator of the video. Note that the videos may have been played “as one” and then have had applied changes (PDLs in metadata) to the visual video impression and unwanted video pieces eliminated. Nonetheless the encoded DEVSA has not been changed or overwritten, thereby minimizing risk of corruption, the expense of re-encoding has been avoided and a quick review and co-sharing of the same video and audio among video editors is enabled.

Much other data may be displayed to the user along with the DEVSA including metadata such as the name of the originator, the name of the video, the groups the user belongs to, the various categories the originator and others believe the video might fall into, comments made on the video as a whole or on just parts of the video, tags or labels on the video or parts of the video.

It is important to note that the interactive functions 215 for reviewing and using DEVSA data, do not link to the DEVSA files, only to the metadata files, it is the metadata files that back link to the DEVSA data. Thus, display control function 216 links to DEVSA files at 212 only to retrieve still images. A major purpose of this data architecture and data system 200 imagines that the DEVSA, once encoded via encodation module 211, is not manipulated or changed and hence speed and video quality are increased, computing and storage costs are reduced. All interactive capabilities are applied at the time of play control that is a read-only process on the DEVSA.

Those of skill in the art should recognize that in optional modes of the above invention each operative user may share their metadata with others, create new metadata, or re-use previously encoded metadata for a particular encoded video.

Referring now to FIG. 3 an operative and editing system 300 comprises at least three linked components, including (a) central servers 307 which drive the overall process along a plurality of user interfaces 301 or networks 305 (one is shown), (b) an underlying programming model 315 housing and operatively controlling operative algorithms, and (c) a data model encompassing 312 and 313 for manipulating and controlling video media, DEVSA, and associated metadata.

Those of skill in the art should understand, that all actual video manipulation is done on the server but that embodiments are envisioned that are solely provided by user software on a user computer. Thus, this concept depicted here preferably envisions that a “desktop” or other user interface device need only to operate web browser software and its own internal video player and display and operating software and be linked to servers 307 via the Internet or another suitable data network connection 305.

Those of skill in the art should understand that the PDL produces a set of instructions for the components of the central system environment, any distributed portions thereof, and any end user device video player and display. The PDL is generated on the server while the final execution of the instructions generally takes place on the end user device.

As a consequence, the present discussion results in “edit-type commands” becoming a subset of the metadata described earlier.

Those of skill in the art should understand that while much of the discussion in this application is focused on video. The capabilities described herein apply equally to audio. They would also apply to many forms of graphic material, and certainly all graphic material which has been encoded in video format. Other than time-dependent functions (that is time internal to the DEVSA), they apply equally to photographic images and to text.

During operation, a user (not shown) interfaces with user interface layer 308 and system environment 307 via data network 305. A plurality of web screen shots 301 is represented as selected version of the process of video image editing that are shown in greater detail with FIGS. 4 through 10.

During personal editing of content, a user (not shown) interacts with user interface layer 308 and transmits commands through data network 305 along pathway 306.

As shown a user has uploaded multiple, separate videos, vid 1, vid 2, vid 3 using respective processes 310, 310′, and 310″. Then via parallel processes 310A the three videos are encoded in processes 311, 311′, and 311″, as shown. In this example we show each video being encoded in two distinct formats (D_{Vid1A}, D_{vid1B}) based either on system administration rules or on user requests. Via path 311A two encoded versions of each of the three videos is stored in 312 labeled respectively D_{vid1A} D_{vid1B} and so on. Following encodation, each respective video is transferred to a DEVSA storage module 312 where those videos of a specific user are retained and identified by user at groupings 312B.

It should be similarly understood, that the initial uploading steps 310A-C for each of the videos generates related metadata and PDLs 313 transferred to a respective storage module 313, where each user's initial metadata is individually identified in respective user groupings 313A.

Those of skill in the art will understand that multiple upload and encode steps allow users to display, review, and edit multiple videos simultaneously. Additionally, it should be readily recognized that each successive edit or change by an individual is separately tracked for each respective video for each user.

When editing multiple videos like this—or just one video—the user is creating a new PDL, which is a new logical object that is remembered and tracked by the system.

As will be understood, videos may be viewed, edited, and updated in parallel with synchronized comments, tagging and identifying.

The present system enables social browsing of others' multiple videos with synchronized commenting for a particular single video or series of individual videos.

A display control 316 receives data via paths 312A and thumbnails via path 320 for initially driving play controller 319 via pathway 318.

As is also obvious from FIG. 3, an edit program model 315 (discussed in more detail below) receives user input via pathway 306 and metadata and PDLs via pathway 321.

Edit program model 315 includes a controlling communication path 322 to display control 316. As shown, edit program model 315 consists of sets of interactive programs and algorithms for connecting the users' requests through the aforementioned user interfaces 308 to a non-linear editing system on server 307 which in turn is linked to the overall data model (312 and 313) noted earlier in-part through PDLs and other metadata.

Since multiple types of playback mechanisms are likely to be needed such as one for PCs, one for cell phones and so on, edit program model 315 will create a “master PDL” from which algorithms can adaptively create multiple variations of the PDL suitable for each of the variety of playback mechanisms as needed. Here, the PDL is executed by the edit program and algorithm module 315, which will also interface with the user interface layer 308 to obtain any needed information, and, in turn, with the data model (See FIG. 2) which will store and manage such information.

Edit program model 315 retrieves information from the data model as needed and interfaces with the user interface 308 to display information to multiple users. Those of skill in the arts of electronic programming should also recognize that edit program model 315 will also control the mode of delivery, streaming or download, of the selected videos to the end user; as well as perform a variety of administrative and management tasks such as managing permissions, measuring usage (via known analysis modes including heat maps, dependency controls, etc.), balancing loads, providing user assistance services, etc. in a manner similar to functions currently found on many Web servers.

As noted earlier the data model generally in FIGS. 1 and 2, manages the DEVSA and its associated metadata including PDLs. As discussed previously, changes to the metadata including the PDLs do not require and in general will not result in a change to the DEVSA. However for performance or economic reasons the server administrator may determine to make multiple copies of the DEVSA and to make some of the copies in a different format optimized for playback to different end-user device types. The data model noted earlier and incorporated here assures that links between the metadata associated with a given DEVSA file are not damaged by the creation of these multiple files. It is not necessary that separate copies of the metadata be made for each copy of the DEVSA; only the linkages must be maintained.

One PDL can reference and act upon multiple DEVSA. Multiple PDLs can reference and act upon a given DEVSA file. Therefore the data model takes special care to maintain the metadata to DEVSA file linkages.

Referring now to FIGS. 4-10, an alternative discussion of images 301 is discussed. In order to demonstrate how the process appears to the user, as one example, a user can edit DEVSA by changing the manner in which it is viewed without changing the actual DEVSA as it is stored.

In FIG. 4, a user may upload via upload modules 310A a series of videos that are individually characterized with a thumbnail image, initial tagging and metadata. The first page is shown.

In FIG. 5, a user may choose to combine, edit, or delete all their video, and each will be listed. Options ask whether to add a video or action to a user's PDL (as distinguished from a user's EDL), and a user may simply click on a “add” indicator to do so. Multiple copies of the same video may be entered as well without limit.

In FIG. 6, a user has added and edited three videos of the user's choosing to the PDL and has indicated a “build” instruction to combine all selected videos for later manipulation.

In FIG. 7, an edit display page is provided and a user can see all selected videos in successively arranged text-like formats with thumbnails via retrieval path 320 equally spaced in time (roughly) throughout each video. Here 2 lines for the first 2 videos and 3 lines for the third video just based on length. Here at the beginning and end of each video there is a vertical bar signifying the same and a user may “grab” these bars using a mouse or similar device and move left-right within the limits of the videos. A thin bar (shown in FIG. 7 about 20% into the first thumbnail of the first video) also enables and shows where an image playback is at the present time and where the large image at the top is taken from. If the user clicks on PLAY above, the video will play through all three videos without a stop until the end thus joining the three short videos into one, all without changing the DEVSA data.

In FIG. 8, a user removes certain early frames in the second two videos to correct lighting and also adjusted lighting and contrast by using metadata tools. A series of sub-images may be viewed by grouping them and pressing “Play.”

In FIG. 9 the user has continued to edit his three videos into one continuous video showing his backyard, no bad lighting scenes, no boat, no “pool cage”. It is less than half the length of the original three, plays continuously and has no bad artifacts. The three selected videos will now play as one video in the form shown in FIG. 9. The user may now give this edited “video” a new name, tags, comments, etc. It is important to note that no new DEVSA has been created, what the user perceives as a new “video” is the original DEVSA controlled by new PDLs, and other metadata created during the edit session described in the foregoing. The user is now finished editing in this example.

In FIG. 10, a user has returned to the initial user video page where all changes have been made via a set of PDLs and tracked by storage module 313 for ready playing in due course, all without modifying the underlying DEVSA video. His original DEVSA are just as they were in FIG. 4.

Other user interface representations of video streams on a two dimensional screen are also possible and could also be used without disrupting the editing images in time sequence as if they were a deck of cards or a book thus creating an apparent three-dimensional object where the depth into the “deck of cards” or the “book” is a measure of time.

Graphical “tabs” could appear on the cards or book pages (as on large dictionaries) which would identify the time (or other information) at that depth into the deck or book. The user could then “cut the deck” or “open the book” at places of his choosing and proceed in much the same way as described above. These somewhat different representations would not change the basic nature of the claims herein. There can be value in combining multiple such representations to aid users with diverse perception preferences or to deal with large quantities of information.

In the preceding it has been assumed that the “user” has the legal right to modify the display of the DEVSA. There may be cases where there are users with more limited rights. The user interface will allow the individual who introduces the video and claims full edit rights, subject to legal review, to limit or not to limit the rights of others to various viewing permissions and editing functions. These permissions can be adjusted within various sub-segments of the video. It is expected that the addition of tags and commentary by others will not generally be restricted in light of the fact that the underlying DEVSA is not compromised by these edit commands

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. An electronic system, for interactive editing of at least a first time-based media by a plurality of users including at least a first user, said electronic system comprising:
at least one user computerized electronic memory device enabling a manipulation of said time-based media;
user interface means for uploading said time-based media from said computerized electronic memory device to means for encoding and for storing said at least first time-based media in at least a first initial encoded state in a networked electronic system environment;
metadata system means for creating, storing, and managing a plurality of layers of metadata each in a manner associated with said at least first initial encoded state of said encoded time-based media without modifying said at least first initial encoded state of said encoded time-based media, and in a manner associated with each respective said user;
electronic interaction system means for enabling said plurality of users to interact respectively with said metadata system means for creating, storing, and managing said plurality of layers of metadata according to stored respective playback decision lists of ones of said plurality of users; and
said electronic interaction system means including means for enabling a plurality of display control modes and a plurality of play modes of said encoded time-based media according to respective said playback decision lists of respective ones of said plurality of users; thereby enabling an electronic system for individual and group user editing of encoded time-based media without re-encoding said first initial encoded state of respective said time-based media.

2. An electronic system, according to claim 1, wherein:
said electronic interaction system enables each respective user of said plurality of users to modify said metadata associated with said first initial encoded state of said time-based media in a plurality of said user playback decision lists; and
each said user playback decision list includes at least one selection selected from a group comprising:
a display control selection, a play control selection, an editing selection, a virtual browsing selection, a commenting to a social browsing selection, a creation of permanent media selection, a sharing of metadata selection, a viewing of metadata selection, and a searching of metadata, whereby said electronic system enables respective said users of said plurality of users to create a plurality of layers of metadata according to said user's playback decision list preference.

3. An electronic system, according to claim 1, wherein:
said metadata system means for creating, storing, and managing a plurality of layers of metadata includes at least one type of metadata selected from a group of metadata comprising:
user identification metadata, time-based media identification metadata, timing information metadata, encoding information metadata including the number and types of encoding, user access information metadata, user groups' metadata, user classes metadata, user playback decision list metadata, display control preference information metadata, play control preference information metadata, and permanent media interaction metadata.

4. An electronic system, according to claim 1, wherein:
said means for encoding and for storing further comprises:
means for encoding and for storing said time-based media in a plurality of encoded states within said electronic system environment; and
said metadata system means for creating, storing, and managing a plurality of layers of metadata for each respective said user of said plurality of users, further comprises:
means for creating, storing, and managing a plurality of layers of metadata separately associated with each respective one of said plurality of encoded states of said time-based media, whereby said electronic system readily adapts to a diversity of time-based media.

5. An electronic system, according to claim 1, wherein:
said user interface means for uploading further comprises:
means for uploading a plurality of different first time-based media from said computerized electronic memory device to means for encoding and for storing each respective different first time-based media in at least a respective first initial encoded state in said networked electronic system environment; and
said metadata system means for creating, storing, and managing a plurality of layers of metadata further comprises:
metadata system means for creating, storing, and managing a plurality of layers of metadata for each respective first time-based media from said plurality of different first time-based media, without modifying each respective said at least first initial encoded state of said encoded time-based media, and in a manner associated with each respective said user;

6. An operational system for editing a plurality of time-based media by a plurality of users, comprising:
a computer system receiving at least a first of a plurality of user uploads of said time-based media in a networked operational environment through at least one user interface system;
means for encoding and storing respective ones of said plurality of user uploads in respective an initial state separate from subsequent user uploads;
a metadata system for establishing metadata associated with said first of said user time-based media separate from said subsequent encodings by said means for encoding;
said computer memory means storing said metadata associated with said time-based media separate from said encoded time-based media in said initial state; and
means interacting with said metadata system for creating and storing a plurality of individual user metadata as distinct individual playback decision lists separately from said respective initial state time-based media and said respective initially established and encoded time-based metadata, thereby enabling individual user playback decision lists associated with said initially established metadata without a modification of said initial state encoded of time-based media.

7. An operational system, according to claim 6, further comprising:
programming module means for individually controlling at least one of a group comprising:
a display control, a play control, and a multi-level user editing of said at least first of said user uploads of said time-based media, whereby said operational system enables a multi-user editing of said at least first of said user uploads and a storage of said respective multi-user edits in said computer memory means for storing without modifying said initial state of said encoded time-based media.

8. An operational system, according to claim 7, further comprising:
means for interacting with said established metadata associated with said time-based media in at least a first edited time-based interaction, whereby said means for interacting includes means for recording and storing said first edited time-based interaction as at least one of said metadata and said playback decision lists linked to said at least first recorded interaction; and
said means for interacting includes means for storing said at least first recorded interaction, whereby a playback of said stored interaction drives a display system displaying according to least one of said metadata and said playback decision list.

9. An operational system, according to claim 7, wherein:
said means for individually modifying said metadata as an individual playback decision list, further comprises:
means for individually tracking a plurality of separate individual modifications of said metadata in respective individual playback decisions lists separate from others of said plurality of respective individual modifications, whereby said operational system enables multiple edits and multiple edit levels of said initially established metadata by multiple users without modifying said initial state encodation of said time-based media or said initially established metadata associated with said initial state, and whereby said means for individually tracking associates each individual modification to each said respective user upload of said time-based media in an initial state thereby allowing said operational system to track multiple user uploads and respective established playback decision lists.

10. An operational system, according to claim 7, wherein:
said metadata system including means for creating and storing a plurality of metadata associated with each said time-based media, including at least one metadata type of a data group consisting of:
author data, permission data, tagging data, deep tagging data, commenting data, synchronized commenting data, grouping data, classes data, commenting data, and naming data, whereby said established metadata and said means for interacting enables said electronic data system to differentiate a plurality of stored playback decision lists based on said at least one metadata type.

11. An operational system, according to claim 10, wherein:
said means for interacting, further comprises:
a transmission module for transmitting said permanent media; and
said transmission module including at least one of a permanent media production system for producing said permanent media, a business system for processing a charge for said production of said permanent media, and a shipping system for transmitting said permanent media as determined by said user.

12. An operational system, according to claim 11, wherein:
said means for interacting and said metadata system enable at least a second stored playback decision list that modifies said stored metadata in a second manner for each respective said user without modifying said encoded time-based media in said initial state encoded standard, and without modifying said first stored play back decision list, whereby said electronic data system enables the generation of a plurality of individual edited playback decision lists in a reduced storage space.

13. An operational system, according to claim 12, wherein:
said means for interacting enables a plurality of said users to interact with respective said stored playback decision list thereby enabling at least one interaction selected from a group comprising:
a searching, a viewing, a sharing, and a showing of respective said stored playback decision lists within a minimized impact on said computer memory means.

14. A method for individual and group editing of time-based media, comprising the steps of:
providing a networked computer system receiving at least a first of a plurality of user uploads of said time-based media in an operational environment through one of a plurality of user interface systems;
enabling means for encoding said at least first of said user uploads of said time-based media in an initial state separately from subsequent user uploads;
supplying and operating computer memory means for storing said encoded first time-based media in said initial state separate from said subsequent user uploads;
operating a metadata system for initially encoding metadata associated with said first of said user time-based media separate from said subsequent user uploads during an encoding by said means for encoding;
providing computer memory means storing said metadata associated with said time-based media separate from said encoded time-based media in said initial state;
providing means for individual and group editing of said metadata as individually tracked playback decision lists and for individually storing said respective said playback decision lists separately from said respective initial state time-based media and said respective initially encoded metadata and subsequently tracked playback decision lists, thereby enabling said individual and group editing of said initial metadata without a modification of said initial state encoded time-based media.

15. A method for individual and group editing of time-based media, according to claim 14, further comprising the steps of:
providing a programming module means for individually controlling at least one of a group comprising:
a display control, a play control, and a multi-level user editing of said at least first of said user uploads of said time-based media, whereby said means for individual and group editing enables a multi-user editing of said at least first of said user uploads of said time-based media and a storage of said respective multi-user edits in said computer memory means for storing without modifying said initial state of said encoded time-based media.

16. A method for individual and group editing of time-based media, according to claim 15, wherein:
said means for individual and group editing enables at least one modification, said modification including at least one of a group comprising:
editing, virtual browsing, tagging, commenting, social browsing, and creation of a permanent media form; and
said permanent media form includes at least one of said time-based media in said first encoded standard and selected metadata associated with said encoded time-based media modified according to said at least one stored playback decision list.

17. A method for individual and group editing of time-based media, according to claim 16, further comprises the step of:
providing a transmission module for transmitting said permanent media form; and
said transmission module includes at least one of a permanent media production system for producing said permanent media, a business system for processing a charge for said production of said permanent media, and a shipping system for transmitting said permanent media as determined by said user.

18. An operational system for enabling individual and group editing of time-based media with a minimized memory requirement, comprising:
at least one operational means for uploading individualized-user time-based media into a networked computer operational environment through at least a first user interface and for encoding said time-based media into a first encoding standard;
a metadata system for establishing metadata associated with said time-based media during said encoding by said means for encoding said time-based media into said first encoding standard;
storage system means for separately storing said encoded time-based media in said first encoding standard and said associated established metadata;
means for displaying at least selected portions of said uploaded and encoded time-based media according to said metadata, wherein a plurality of thumbnail frame images are displayed in a time-related sequence;
said time-related sequence representing selected images along a time path of said encoded video media;
slider means for interacting with and selecting at least one of preferred ones of said thumbnail frame images and a preferred range of said thumbnail frame images of said video media and for storing said at least one as a respective user defined playback decision list without modifying said stored and encoded time-based media in said first encoding standard, whereby said selected at least one playback decision list is separately tracked by said operational means linked to said individualized encoded time-based media, with a minimized memory storage impact.

19. An operational system, according to claim 18, further comprising:
means for interacting with said selected portions of said uploaded and encoded time-based media enabling at least one of a display of user-selected ones of said plurality of thumbnail frame images; and
means for adjusting one of a time sequence and a time display of said time-related sequence for each said user-selected ones of said plurality of thumbnail frame images, whereby respective users may select individual displays of thumbnail images based on a user preference.

20. An operational system, according to claim 19, wherein:
said means for interacting further enables a multiple user modification of respective user-defined playback decision lists, whereby said modifications include at least one of a modification group comprising:
editing, virtual browsing, tagging, deep tagging, synchronized tagging, commenting, synchronized commenting, social browsing, and creation of a permanent media form, whereby said operational system provides an enhanced video data editing experience.

21. An operational system, according to claim 20, wherein:
said permanent media form includes at least one of said time-based media in said first encoded standard and metadata associated with said encoded time-based media modified according to said respective user defined stored playback decision list.
